(19) United States
(12) Patent Application Publication
(10) Pub. No.: US 2010/0165859 A1
(43) Pub. Date: Jul. 1, 2010

(54) SORTING FLOW RECORDS INTO ANALYSIS BUCKETS

(76) Inventors: Herve Marc Carruzzo, Atlanta, GA (US); Todd Andrew Vierling, Atlanta, GA (US); Michael R. White, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/572,290

(22) Filed: Oct. 2, 2009

Related U.S. Application Data
(60) Provisional application No. 61/141,894, filed on Dec. 31, 2008.

(51) Int. Cl. H04L 12/26

(52) U.S. Cl. 370/252

(57) ABSTRACT

Flow information records are identified and sorted out based on the sending and/or receiving customer. Prior art problems are overcome by using a combination of router identification, SNMP numbers and interface numbers to identify the source and destination of data flow records. A flow information packet containing one or more information flow records is received at a flow process and parsed to identify the router source. The datagram of the flow information packet is examined to identify an SNMP number associated with the source and/or destination affiliated with the flow information packet. Based on the SNMP number, the interface of the router associated with the datagram is identified and the records are accordingly sorted into buckets.

### CROSS-REFERENCE TO RELATED APPLICATIONS

This application is being filed under 35 USC 111 and 37 CFR 1.53(b) and claims the benefit of the filing date of the United States Provisional Application for Patent having a title of SORTING FLOW RECORDS INTO ANALYSIS BUCKETS filed on Dec. 31, 2008 and assigned Ser. No. 61/141,894 and is related to and incorporates by reference the United States Application for Patent having a title of NETWORK FLOW VOLUME SCALING, filed concurrently with this application and identified by attorney docket number 09012.1015 and Ser. No. 12/______,

### BACKGROUND

This invention relates to systems and methods to appropriately attribute, identify or assign Internet Protocol (IP) Flow record information to individual users where the underlying infrastructure for accessing the Internet is being shared by multiple distinct entities or users.

There is great need and interest in collecting information about traffic and traffic flow within an IP network. This information can be used in a variety of manners to help improve the overall operation of a network, control the operation of a network, control network access, generate billing/usage reports, etc. To facilitate services such as measurement, accounting, and billing, applications have been developed to utilize the traffic and traffic flow information. Such applications include mediation systems, accounting/billing systems, and network management systems. Those skilled in the art will appreciate that many more types of applications are also available and dependent upon similar information.

One way of obtaining traffic and traffic flow information on in IP network is through “Netflow”, an open but proprietary CISCO implementation and its emerging Internet Engineering Task Force (IETF) standard companion, the Internet Protocol Flow Information eXport (IPFIX). Other vendors, such as Foundry and Juniper also have implementations or products for obtaining traffic and traffic flow information. The IPFIX standard, generated by an IETF working group, was created to address the need for a common universal standard of export for Internet Protocol Flow information primarily from routers, but has now been extended to include a variety of similar devices. The IPFIX standard is aimed at defining how IP flow information is to be formatted and transferred from an exporter to a collector. For the purpose of Netflow and IPFIX, a flow is a unidirectional sequence of IP packets sharing all of the following seven fields:

Source IP address

Destination IP address

Source port

Destination port

IP protocol

Ingress interface

IP Type of Service

A router will export a flow record when it determines: (a) that the flow has been completed or (b) at regular intervals, regardless of the status of a flow. The exported flow records can contain a variety of information that can be useful. In most cases, the following fields exist within a flow record:

(a) input and output interface SNMP indices; and

(b) the number of bytes.

In addition, many routers and systems offer the ability to export sampled flow records. On a particular interface, the sampled flow capability allows for the collection of flow statistics for a subset of incoming Internet Protocol version 4 (IPv4) traffic on the interface. This operates by selecting only one out of “N” sequential packets, where “N” is a configurable sampling parameter. Operating in this manner has the advantage of considerably reducing the load on the router. However, this manner of operation also works to diminish the accuracy of the information as the sampling rate is decreased. The data extracted from the flow record using the sampling technique is then scaled up by the sampling parameter.

Because each interface can, in principle, have its own sampling parameter, an additional burden is incurred in tracking this parameter for each interface. The flow records are typically exported using the UDP protocol, although some implementations allow TCP to be used. It is often the case that routers export flow record information themselves. However the same results can also be obtained utilizing special purpose, standalone flow collection probes. These probes see the traffic via a TAP or SPAN port on the switch/router of interest and export the same flow record information as the routers can.

In either case, the data obtained from a router simply reflects that data that passes through the router. In essence, it is a summary of information flow. However, when trying to attribute traffic to individuals or entities, the information available from such an information flow summary is not sufficient. What is needed in the art is a technique to identify and associate traffic through a router with individual users or entities.

In some situations, the owner or operator of a router, or other similar device through which the traffic flows, also delegates the IP blocks to the various entities. This technique is insufficient to provide the information typically required. For example, when using this technique it can be very cumbersome to keep track of each delegated IP block for each entity, and difficult to keep the information current at all times. In situations where the entity uses the Border Gateway Protocol for routing traffic, most of the time tracking information will fail as it is not possible to know the complete list of source IP addresses or destination IP addresses advertised by this entity.

### SUMMARY

Various embodiments of the present invention are directed towards techniques to associate flow record information with entities from which the traffic originates or to which the traffic is destined. As an example, an entity can be a corporation, an individual or a department that possesses the exclusive rights to use one or more interfaces on a device, such as a router, whose traffic the flow record information reflects. For given flow records, the traditional way to associate a subset of the traffic with a particular entity involves matching the source or destination IP address read from the flow record information with a previously constructed list of IP addresses for each entity whose traffic information must be segregated from the rest. However, this technique is often not practical and in many situations downright impossible.

One advantage present in one or more embodiments of the present invention provides a method that does not require knowing the list of IP addresses that belong to each entity while still allowing the flow record to be correctly associated with each entity.

Another advantage that can be included in various embodiments of the invention operates to overcome the often inaccurate nature of the data volumes obtained from flow information. This inaccuracy can be induced by any one of at least three sources:

(a) the router load;

(b) the possible existence of a sampling mode running on one or more interfaces; and

(c) dropped UDP packets transferred between the exporting router and the flow processing system (if UDP is the chosen protocol, which is the most common choice).

A more detailed description of these three sources helps to understand this issue. The first source of inaccuracy is the router load. The primary purpose of a router is to route traffic. Because of this, other operations that are considered nonessential, or secondary to the routing of traffic, are typically operated on as low priority tasks. One such nonessential task is the flow processing for export. When the flow processing is operated on as a low priority task, the expected result is that the exported flows do not necessarily or accurately reflect the actual traffic volumes. This is due to the fact that much of the flow information can be lost while the router focuses on routing the traffic rather than exporting the flow records.

The second source of inaccuracy can be induced by sampling. The sampling process itself is a static process and can be normalized simply by multiplying the obtained count by the sampling parameter. However, the act of sampling adds an inherent statistical uncertainty that cannot be compensated for completely.

Finally, the protocol most often used to transfer the flow information between routers and the flow processing entities is UDP. UDP, unlike TCP, is a protocol that does not ensure that all packets make it from source to destination. This source of dropped packets results in missing flow information which directly impacts the accuracy of the volumes of traffic inferred from the exported flows.

The various embodiments of the present invention operate to overcome these inaccuracies in overall traffic volumes as obtained from the flow data. Some embodiments of the present invention can overcome these inaccuracies regardless of the source of the uncertainty but, may particularly focus on addressing the above described primary sources of inaccuracies. Some embodiments may even focus on accomplishing this task within a particular time window.

One embodiment of the present invention includes a system that consists of one or more routers exporting flow record information to one or more flow record processors. This system may operate to export the flow records either directly or indirectly (i.e., via a special purpose system aware of the full IP traffic through a test access point (TAP) or a switch port for analysis (SPAN) port on each router). In further describing this embodiment, the system is described as including a single flow record processor. However, those skilled in the art will appreciate that the system can be easily expanded to include two or more flow record processors. The system also includes a repository containing a reference identifier for each interface and its associated SNMP number and router identifier. This reference identifier operates to link a particular interface and router to an ‘owner’. In some embodiments, this repository is automatically updated for SNMP number changes as dictated by the router.

In addition, the system includes a mechanism to collect traffic volume information for each interface of interest by use of the SNMP protocol. This overall volume information can then later be used to correct for flow volume inaccuracies. The system may also include a repository that can provide a map between the loopback interface IP address and the corresponding router identifier. By looking up the source IP of the packet encapsulating the flows, the source and destination interface information in each flow can then be mapped to a specific entity.

### BRIEF DESCRIPTION OF THE DRAWINGS

The foregoing and still further objects and advantages of the present invention will be more apparent from the following detailed description containing exemplary embodiments of the present invention along with the accompanying drawings in which:

FIG. 1 is a block diagram illustrating an overview of a typical environment in which embodiments of the present invention can operate;

FIG. 2 is a diagram depicting a flow exporting device having multiple user connections and network provider connections;

FIG. 3 is a diagram depicting the flow exporting device of FIG. 2 along with the addition of a network monitoring system to keep track of the association between interface SNMP numbers and users;

FIG. 4A is a flow diagram illustrating exemplary steps in an embodiment of the invention that operates to extract the origin router of the flow;

FIG. 4B. is a flow diagram illustrating exemplary steps in an embodiment of the invention that operates to perform the association of a flow to a user (entity); and

FIG. 4C. is a flow diagram illustrating further details in exemplary steps in an embodiment of the invention that operates to perform the association of a flow to a user (entity).

### DETAILED DESCRIPTION OF THE PREFERRED EMBODIMENT

The various embodiments of the present invention build on existing technology to help extract and obtain specific information about traffic flow. In general, embodiments of the invention focus on identifying data traffic occurrences and appropriating the data traffic to the correct party (either generator or receiver). The Internet is shared by a vast amount of users and so, it can be quite problematic for an internet service provider (ISP) to identify which of the many customers is sending data. For routing traffic, it is not important to determine the appropriation of traffic. However, for reporting purposes it is quite important. Routers are able to export a summary of traffic that the router sees passing through it. The information provided summarizes the volume of traffic that passes through the router but, does not provide a break down as to the actual user generating the traffic.

A router typically includes several interfaces with each interface is a connection through which customer traffic is going in or out and connects to a particular customer. However, typical billing systems and network monitoring systems obtain aggregated traffic for billing. This information is available through the Netflow system from CISCO. Netflow provides granular bits of information about traffic. The Netflow splits out information for aggregated traffic. By examining this information, the source IP address, the destination IP address and the traffic volume can be determined. However, because it is difficult to determine which user or customer a particular IP address belongs to, it is necessary to user an alternative technique to appropriate the traffic.

Billing systems typically are designed to ensure that SNMP numbers are consistently attributed to customers in a consistent manner. The Netflow product provides flow information in a UDP packet. In essence, the embodiments of the present invention operate to place data into buckets based on information that is gleamed from the available information. For instance, a UDP packet received from Netflow can be traced to a particular router providing the packet. The datagram provides an SNMP number which in turn is associated with a particular interface on the router. Thus, the traffic from the particular interface can then be attributed to a particular customer. Knowing this information, traffic is obtained and placed into various buckets (i.e., one bucket for each customer). Once the data information is placed in a bucket, the data can then be analyzed on a source and destination IP address basis, or other basis to identify particular traffic characteristics.

Now turning to the figures, various embodiments of the invention, as well as features and aspects of these embodiments are provided with more specificity. It should be appreciated that the described embodiments are provided as non-limiting examples of the invention. Further, those of ordinary skill in the art should appreciate upon reading the present specification and viewing the present drawings that various modifications can be made and that trivial adaptations to slightly different types of flow records can be made.

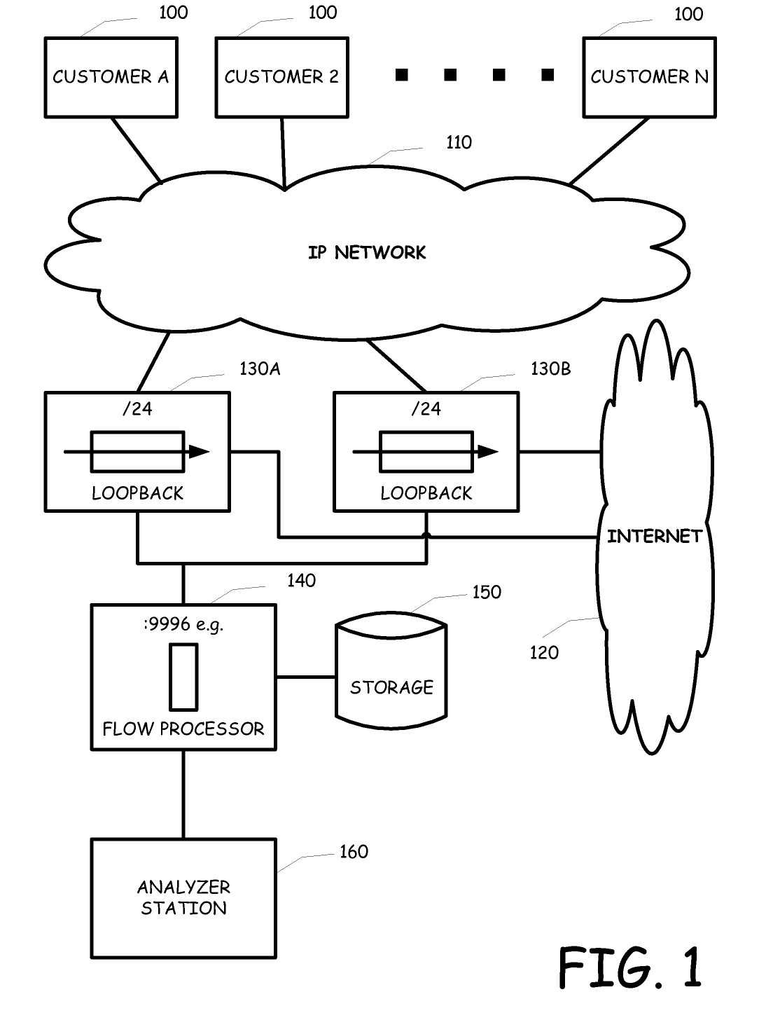

FIG. 1 is a block diagram illustrating an overview of a typical environment in which embodiments of the present invention can operate. FIG. 1 illustrates multiple end users or entities 100 that are communicatively coupled to an IP network 110. FIG. 1 also illustrates two flow exporting devices 130A and 130B (collectively or generically referenced as element 130) as also being communicatively coupled to the IP network 110. Although only two flow exporting devices are illustrated, it should be appreciated that any number of flow exporting devices may be utilized. In addition, in an exemplary embodiment, the flow exporting devices 130 also operate as traffic routers and, although the flow exporting function and the routing function are illustrated in a single block, the two functions can in practice be separated. Therefore, throughout this description, the term ‘router’ will be used to refer to both the traffic routing device and the flow exporting device unless specifically indicated as being different.

IP traffic from an end entity 100 flows to a router 130 through the IP network 110 and, flows from a router 130 to an end entity 100 through the IP network 110.

The routers are shown as sending flow records to a flow processing device 140. For the sake of simplicity, FIG. 1 only illustrates a single flow processing device 140; however, those skilled in the art will appreciate that the extension to multiple such flow processing devices is trivial deviation from the illustrated embodiment. As such, various embodiments of the present invention anticipate the use of a single or multiple flow processing devices.

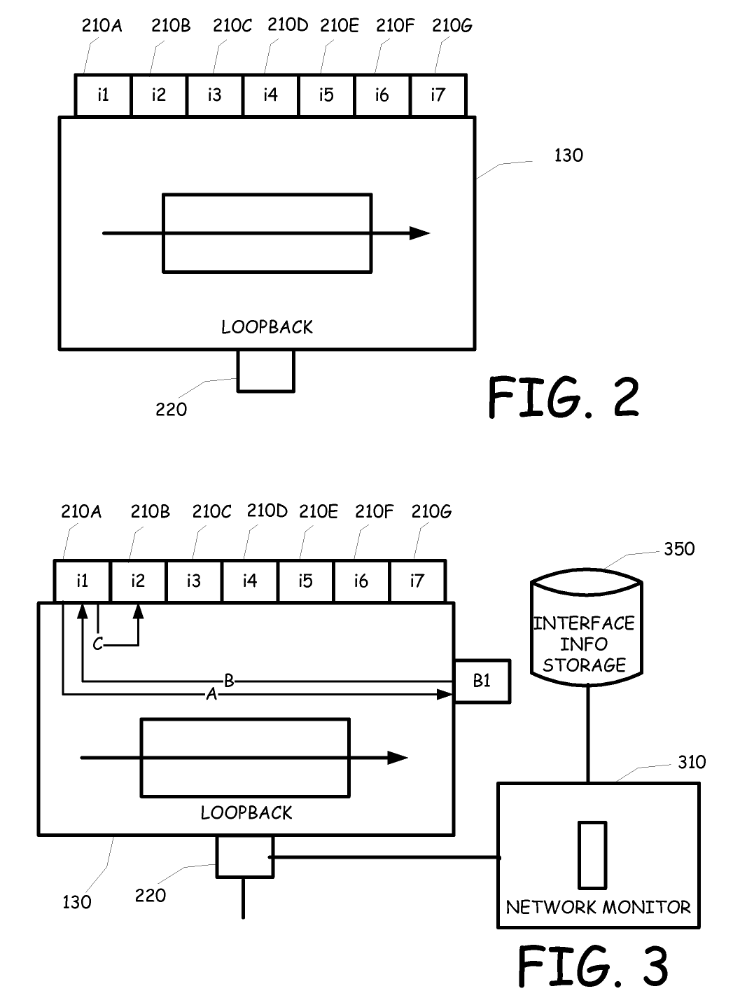

The traffic that is sent to or received from the end entities 100 uses a specific interface on the router (as further described in conjunction with FIG. 2). As a non-limiting example, the end entities 100 can be customers of an Internet Service Provider that operates the routers 130. In addition, a number of interfaces on the routers 130 are used to connect to the Internet 120. The traffic may be routed through a variety of protocols, including Open Shortest Path First (OSPF) and the Border Gateway Protocol (BGP). The flow exporting devices 130, which include routers in this embodiment, are configured to export flows to a flow processing device 140 using a specific IP address and port. Often port 9996 is utilized, however, the use of this port is generally a matter of convention and is not critical to any embodiment of the invention.

It should be noted that multiple exporting devices can be configured to export flows to the same flow processing device 140. The flow processing device 140, operating in conjunction with or under the control of the analyzer station 160, operates to analyze the flows, perform the necessary classifications and possibly storing historical information onto a storage device 150. In addition, the flow processing device 140 provides a mechanism for an end user or another entity to access the processed flow information.

Currently, a list of IP addresses matched to specific customers is maintained as a MAP source ID to customer. This information is relied upon for data segregation. However, such reliance has at least to downfalls. First of all, the list of source IP addresses and customers needs to be maintained. This can be quite difficult as the list can change overtime. For instance, a customer may add a new computer with a ne IP address. As another example, a customer may change to a different block of IP addresses. Secondly, the list of IP addresses may not be a static list. The list could include IP addresses routed via the BGP or Border Gateway Protocol that advertise a set of IP address that can dynamically change and actually belong to others. For instance, they may accept traffic on behalf of other parties (transit traffic). These factors, as well as potentially others can make it exceedingly difficult to maintain the source IP address to customer list.

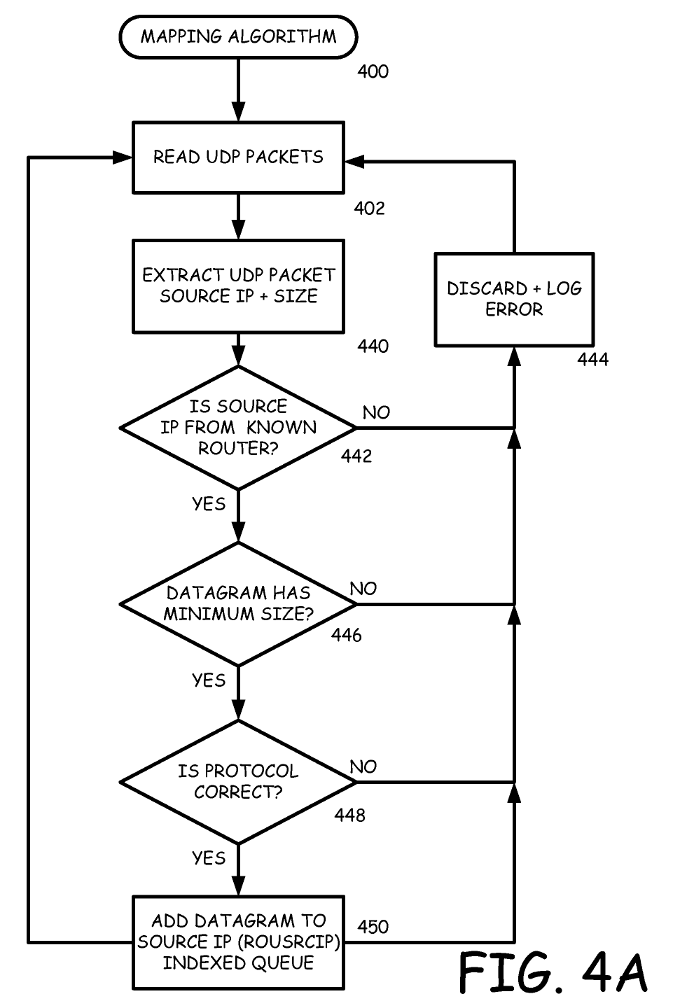

FIG. 2 is a diagram depicting a flow exporting device having multiple user connections and network provider connections. FIG. 3 is a diagram depicting the flow exporting device of FIG. 2 along with the addition of a network monitoring system to keep track of the association between interface SNMP numbers and users.

A network monitor 310, as illustrated in FIG. 3, maintains a list of interfaces (such as interface i1 to i7 210A-210G) for all routers and stores this list in an interface information storage device or structure 350 so that the information is available for processes or entities to search or query. The information stored about each interface can include the SNMP number of the interface, as well as an identifier—typically a string describing the interface. This identifier is used to link a given interface to a given entity, as is normally done for billing or traffic volume measurements via the Simple Network Management Protocol (SNMP). The network monitor 310 also operates to keep track of all changes occurring on the router 130. In particular, an accounting must be conducted for SNMP renumber operations. The SNMP renumbering operations can be invoked or initiated for a number of reasons, such as card moves as a non-limiting example. These changes are either updated with each manual change (e.g. a card move or replaced) or on a regular basis and/or using traps that a router can be configured to emit when an SNMP renumbering operation occurs. In addition, the network monitor 310 operates to measure traffic volume on a per interface basis using SNMP to obtain the number of bytes that went through each interface on a set time period, typically in the range of 5 minutes.

The interface information storage component 350 is in essence, a database that links the identifier of each interface with the entities associated with that interface. This database contains the business information about the end users or entities 100 pushing or receiving traffic though the interfaces of the router 130. The database 350 may be part of an asset management system or specifically provided for the purpose of the various embodiments of the present system.

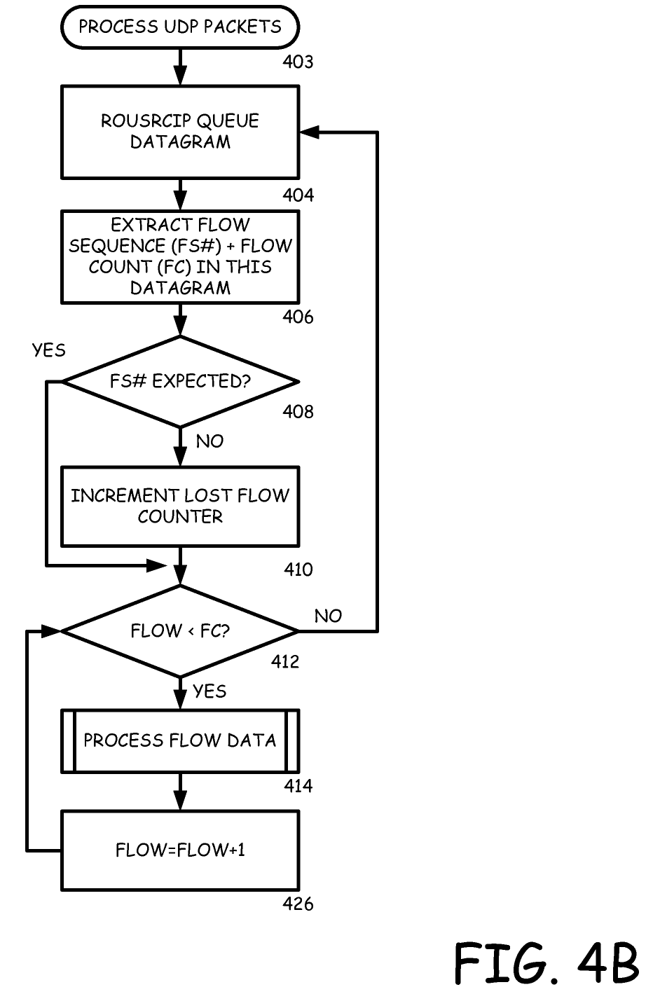

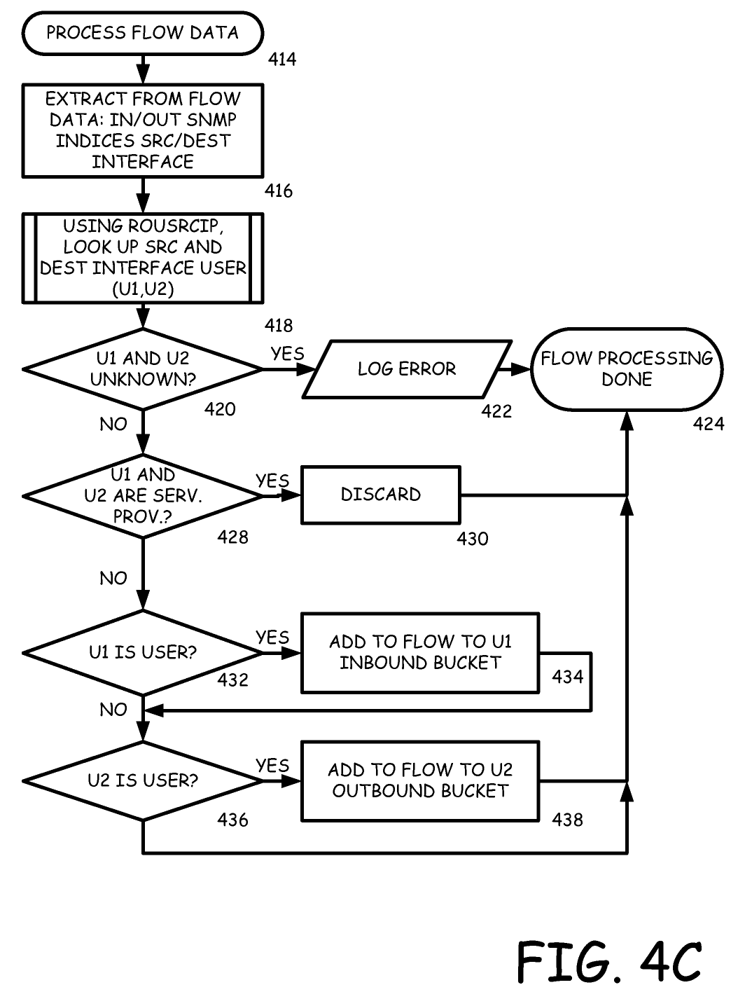

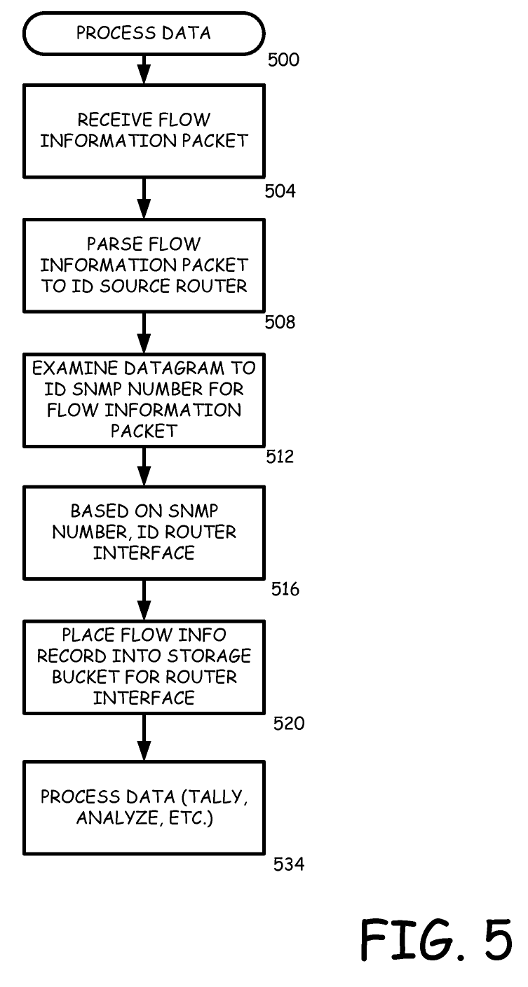

FIGS. 4A-4C are flow diagrams illustrating exemplary steps in an embodiment of the invention that operates to extract the origin router of the flow and further illustrates a conceptual view of a mapping algorithm. For purposes of FIGS. 4A-4C, it is assumed that a set of routers are set up to send their flow information to a flow processing unit. The flow processing unit includes a system that processes the incoming packets and performs the desired classifications.

The mapping algorithm 400 begins by initially reading or obtaining a UDP packet 402.

Once the UDP packet is read, several steps are performed to determine if the packet includes datagrams that should be entered into a source IP indexed queue. The first step in the process includes extracting the UDP packet source IP and size 440. If the source IP is not from a known router 442, the packet is discarded and an error is logged 444.

Next the datagram is examined to ensure that it satisfies size requirements, such as having a minimum size 446. If the datagram does not satisfy the size requirements, the processing continues at step 444. Otherwise, processing continues at step 448 to determine if the protocol is correct. If the protocol is not correct, then the packet is discarded at step 444. Otherwise, the datagram is added to the source IP (RouSrcIP) indexed queue 450 and processing returns to step 402 to read more UDP packets.

FIG. 4B is a flow diagram illustrating the process for extracting datagrams from the RouSrcIP queue and processing the datagrams. In this process 403 for processing the UDP packets, the datagram is extracted from the RouSrcIP queue 404. The datagram is examined to extract a flow sequence number (FS #) and a flow count (FC) from the datagram 406. If the flow sequence number received was not the expected flow sequence number 408, then a lost flow counter is incremented appropriately 410. For instance, if the sequence number is one greater than the expected flow sequence number, then the lost flow counter is incremented by one. However, the lost flow counter can be incremented by any number representing the difference between the received flow sequence number and the expected flow sequence number.

If the flow sequence number extracted is the expected flow sequence number 408, the processing continues at decision block 412.

At decision block 412, the flow is examined to determine if it is less than the flow count. If the flow is less than the flow count, then processing continues at process flow data function call 414. Otherwise, processing returns to step 404 to continue with the next packet.

The process flow data process 414 operates to perform a deeper inspection of the packet by extracting the source and destination interfaces (SrcInt and DestInt) for each flow F contained in the packet 416. Because the packet includes the IP address of the router, it is easy to determine from which router the packet was received. The datagrams include information to determine the SNMP number associated with the source and the destination interface on the router. Knowing the router and the SNMP numbers enables the particular interface of the router to be determined. Further, because each interface is associated with a particular customer, this provides conclusive information as to the customer associated with the data. Using the RouSrcIP information, the network monitor component can be queried for the owner or user of the SrcInt and DestInt (i.e., users U1 and U2) 418. If no owner is found for either the SrcInt or the DestInt (i.e., U1 and U2 are unknown) 420, then the flow is discarded and an error is logged by incrementing a counter for discarded flows 422. It should be appreciated that in some embodiments, additional information might be extracted from this discarded flow for reporting (e.g. the volume associated with the discarded flow).

Processing then returns to step 426 of FIG. 4B where the flow is incremented by one and processing continues at step 412.

However, if the owner information is found, then the owner to which the SrcInt and DestInt belong is known. Three cases are possible:

(a) both SrcInt and DestInt belong to an end entity,

(b) one belongs to an end entity and one belongs to the network operator, or

(c) both belong to the network operator.

For purposes of this description, the term network operator is to be understood to be the party responsible for the operation of the routers of interest. The last case identified above where both the SrcInt and DestInt belong to the network operation should not happen in a correctly set up network. Thus, if U1 and U2 are both a service provider 428, then the flows will be discarded (with logging) 430. The second case is generally the most frequently occurring case. In this case, the flow and its direction can be associated with an end entity. The direction is provided by inspection of which interface, SrcInt or DestInt, actually matched the end entity. Typically, if the SrcInt belong to the end entity, the flow is from that end entity to the network operator (we will refer to this as inbound traffic, taking the point of view of the network operator—shown by path A in FIG. 3). If the DestInt belongs to an end entity, the flow is from the network operator (i.e. from the Internet at large) to that end entity (which we will refer to as outbound traffic—shown as path B in FIG. 3). The last case to be examined corresponds to flows from one end entity to another end entity. In this case, the flow is added to both end entities, inbound on one and outbound on the other (shown as path C in FIG. 3).

Thus, if at least one of the owners U1 or U2 is not a service provider, then they are added to an appropriate bucket. If U1 is a valid user 432, then the flow is added to the U1 inbound bucket 434. Similarly, if U2 is a valid user 436, then the flow is added to the outbound bucket for U2 438. The operations just described ensure that each flow is associated with end entities either on their inbound queue or their outbound queue (or both). At this point, the total traffic volume for each individual entity can be computed and any additional categorization can be performed such as, but not limited to:

(a) classification by destination or source IP,

(b) classification by traffic type, etc.

Such classified information can further be stored in a database for example. An application can then be built to display the information as desired.

Once the inbound and outbound buckets have been added to, flow processing is done 424 and processing returns to step 426 where the flow is incremented and processing continues again at step 412.

FIG. 5 is a flow diagram illustrating a summarization of a typical embodiment of the present invention. The various embodiments may operate to process data 500 in accordance with the illustrated steps by first receiving a receiving a flow information packet containing one or more information flow records 504. The flow information packet is then parsed to identify the router source of the flow information packet 508. The router source is typically identified by examining the IP address in the flow information packet. This IP address identifies the router from which the flow information packet was sent. The datagram of the flow information packet is then examined to identify an SNMP number associated with the source and/or destination interface on the flow exporting router affiliated with the flow. As previously mentioned, the SNMP numbers are automatically maintained and a reliable method to identify a source and destination interfaces. Based on the SNMP number, the interface of the router associated with the datagram can thus be easily ascertained 516. Having this knowledge, the flow information record can then be placed or stored into a storage bucket based on the identified router interface.

Advantageously, the various embodiments of the present invention separate out the information flow records based on router interface—which is then tied to a specific customer. At this point, the information flow records in the various buckets can be analyzed or processed to gain further knowledge in the appropriation of traffic volume. This is accomplished by examining the data in each bucket to identify the source IP address and destination IP address associated with each flow record 534. It should be appreciated that further processing can also be performed. For instance, the process may tally the amount of traffic associated with each source IP address and destination address. Alternatively or in addition to, the flow records can be examined and placed into sub-buckets based on a variety of criteria. As a non-limiting example, the additional criteria may include the type of data (streaming, HTTP traffic), the content of the data (text, graphics, etc), or any of a variety of other criterion.

Thus, the information provided through Netflow is all missed up and the embodiments of the present invention operate to separate the data out into various buckets. Once separated, the data can be analyzed on a more granular level to determine the actual source and destination IP addresses.

It will be appreciated that the various embodiments described, along with various aspects, features or functions have been provided as examples to generally describe the operation of the invention and not to limit the invention. Various embodiments may include only some of the described features whereas other embodiments may include all features. As such, the present invention is only limited by the claims as provided herein.

What is claimed is:

1. A method for sorting flow information records comprising the steps of:
receiving a flow information packet containing one or more information flow records;
parsing the flow information packet to identify the router source of the flow information packet;
examining a datagram of the flow information packet to identify an SNMP number associated with the source and/or destination affiliated with the flow information packet;
based on the SNMP number, identifying the interface of the router associated with the datagram; and
placing the flow information record into a storage bucket based on the identified router interface.

2. The method of claim 1, wherein the step of placing the flow information record into a storage bucket further comprises:
if the sending interface is identified, placing the flow information record into a bucket associated with the sending interface; and
if the destination interface is identified, placing the flow information record into a bucket associated with the destination interface.

3. The method of claim 2, wherein if the sending interface and the destination interface are associated with a network provider, further comprising the step of discarding the flow information record.

4. The method of claim 2, wherein if the sending interface and the destination interface are unknown, further comprising the step of logging an error.

5. The method of claim 2, further comprising the steps of:
examining the data in each bucket to identify the source IP address and destination IP address associated with each flow record; and
tally the amount of traffic associated with each source IP address and destination address.

6. The method of claim 2, wherein the step of parsing the flow information packet to identify the router source of the flow information packet further comprises identifying the IP address of the router.

7. An apparatus to facilitate the sorting of flow information records for further analysis, the apparatus comprising:
a flow processor having an interface to one or more routers; and
a storage device coupled to the flow processor;
wherein the flow processor is operative to:
receive a flow information packet containing one or more information flow records over the router interface;
parse the flow information packet to identify the identify of the router sending the flow information packet;
examine the flow information packet to identify an SNMP number associated with the source and/or destination affiliated with the flow information packet;
based on the SNMP number, identify the interface of the router associated with the datagram; and
place the flow information record into a storage bucket within the storage device based on the identified router interface.

8. The apparatus of claim 7, wherein the flow processor is operative to place the flow information record into a storage bucket by:
if the sending interface is identified, placing the flow information record into a bucket associated with the sending interface; and
if the destination interface is identified, placing the flow information record into a bucket associated with the destination interface.

9. The apparatus of claim 8, wherein if the sending interface and the destination interface are associated with a network provider, the flow processor is further operative to discard the flow information record.

10. The apparatus of claim 8, wherein if the sending interface and the destination interface are unknown, the flow process is further operative to log an error.

11. The apparatus of claim 8, further comprising an analyzer station communicatively coupled to the flow processor, the analyzer station operative to interface with the flow process and the storage device to:
examine the data in each bucket to identify the source IP address and destination IP address associated with each flow record; and
tally the amount of traffic associated with each source IP address and destination address.

12. The apparatus of claim 8, further comprising an analyzer station communicatively coupled to the flow processor, the analyzer station operative to interface with the flow process and the storage device to:
examine the data in each bucket to identify the source IP address and destination IP address associated with each flow record;
analyze the flows to determine the amounts of traffic attributed to various entities;
perform classifications of the data; and
store historical information onto the storage device.
tally the amount of traffic associated with each source IP address and destination address.

13. The apparatus of claim 8, wherein the flow process is operative to parse the flow information packet to identify the router source of the flow information packet by identifying the IP address of the router.
